(19) United States
(12) Patent Application Publication
(10) Pub. No.: US 2026/0242655 A1
(43) Pub. Date: Aug. 20, 2026

(54) VISCOSITY REDUCER AND PREPARATION METHOD THEREFOR AND USE THEREOF, AND METHOD FOR IMPROVING CRUDE-OIL POLLUTION RESISTANCE OF DRILLING FLUID

(71) Applicants: China Petroleum & Chemical Corporation, Beijing (CN); Sinopec Oilfield Service Corporation, Beijing (CN); Sinopec Shengli Petroleum Engineering Co., Ltd, Dongying, Shandong (CN); Drilling Fluid Technology Service Center of Sinopec Shengli Petroleum Engineering Co., Ltd, Dongying, Shandong (CN)

(72) Inventors: Ke LI, Dongying, Shandong (CN); Hongxiang ZHAO, Dongying, Shandong (CN); Haiqing ZHANG, Dongying, Shandong (CN); Qiang LAN, Dongying, Shandong (CN); Haibin LI, Dongying, Shandong (CN); Wei WANG, Dongying, Shandong (CN); Mingxin MA, Dongying, Shandong (CN); Chunxu YANG, Dongying, Shandong (CN); Zhendong LIU, Dongying, Shandong (CN); Yunfeng LUO, Dongying, Shandong (CN)

(73) Assignees: China Petroleum & Chemical Corporation, Beijing (CN); Sinopec Oilfield Service Corporation, Beijing (CN); Sinopec Shengli Petroleum Engineering Co., Ltd, Dongying, Shandong (CN); Drilling Fluid Technology Service Centerof Sinopec Shengli Petroleum Engineering Co., Ltd, Dongying, Shandong (CN)

(21) Appl. No.: 19/164,634

(22) PCT Filed: Mar. 21, 2024
(86) PCT No.: PCT/CN2024/083071

§ 371 Date: Sep. 12, 2025

(30) Foreign Application Priority Data
Apr. 27, 2023 (CN) 202310474265.4

(51) Int. Cl. C09K 8/035; C09K 8/03

(52) U.S. Cl. CPC C09K 8/035; C09K 8/032

(57) ABSTRACT

Described are a viscosity reducer and a preparation method therefor and the use thereof, and a method for improving the crude-oil pollution resistance of a drilling fluid. The viscosity reducer includes a matrix and particles attached to the surface of the matrix and/or wrapped in the matrix. The matrix includes an oleophilic moiety and a hydrophilic moiety. The particles do not melt at 100° C. or lower. The number of the particles in the viscosity reducer in an area of 10*10 μm is 1-1500 according to analysis using a scanning electron microscope. The viscosity reducer can be applied to an oil-based drilling fluid and a synthetic drilling fluid to improve the crude-oil pollution resistance of the drilling fluids; and the viscosity reducer can also be used in a drilling fluid permeated by crude oil, so as to alleviate the problem of thickening caused by crude oil permeating the drilling fluid.

### CROSS-REFERENCE TO RELATED APPLICATIONS

The application claims the benefit of the China patent application No. “202310474265.4”, filed on Apr. 27, 2023, the content of which is specifically and entirely incorporated herein by reference.

### TECHNICAL FIELD

The present invention relates to the technical field of drilling fluids, in particular to a viscosity reducer and a preparation method therefor and the use thereof, a method for improving the crude-oil pollution resistance of a drilling fluid.

### BACKGROUND ART

The widespread application of synthetic drilling fluids has caused that the research and use of drilling fluid treatment agents have drawn more and more attention from the people, which has also driven the advancement of drilling fluid technology and use level to some extent, and the gradual perfection of the drilling fluid systems has met the needs for safe, smooth and efficient drilling in a wide variety of different construction conditions. In recent years, despite there are many researches with respect to the drilling fluid viscosity reducers, only a few product has provided significant breakthrough in properties and put into the production and application, there are still major limitations for the researches, and the coverage remains narrow. In particular, there are still a large number of blank spaces in the viscosity reduction of drilling fluid permeated by the crude oil with the high freezing point and high viscosity.

The intrusion of crude oil into the oil-based drilling fluid/synthetic drilling fluid, it causes the drilling fluid to thicken or even lose mobility, which affects the normal circulation of the drilling fluid. The conventional treatment methods in the prior art in regard to the intrusion of crude oil into the drilling fluid usually comprise the dilution method or the displacement method, but the method has disadvantages such as high treatment cost and large environmental protection pressure. To solve the problem concerning deterioration of the rheological property of the drilling fluid caused by the intrusion of crude oil into the drilling fluid, it requires that the viscosity reducer has desirable compatibility with the drilling fluid and the excellent viscosity reduction effect on the crude oil. CN106318348A discloses a drilling fluid for resisting heavy oil pollution, the drilling fluid is prepared by reasonably compounding water, sodium bentonite, sodium carbonate, sodium carboxymethyl cellulose, low viscosity polyanionic cellulose, a filtrate reducer A, sulfonated phenolic resin, sulfonated lignite, industrial salt, an emulsifier B, an emulsifier C and barite, can maintain good rheological properties and increase the capacity limitation of heavy oil, after the drilling fluid is polluted by 25% heavy oil, the drilling fluid still has good rheology and filtration loss property. However, the drilling fluid suffers from large limitations, and there is not an effective viscosity reduction means for the intrusion of crude oil into the oil-based drilling fluid/synthetic drilling fluid.

### SUMMARY OF THE INVENTION

The present invention aims to overcome the defects in the prior art with respect to thickening and poor fluidity of drilling fluid after the intrusion of crude oil into an oil-based drilling fluid/synthetic drilling fluid, provides a viscosity reducer and a preparation method therefor and the use thereof, and a method for improving the crude-oil pollution resistance of a drilling fluid, the viscosity reducer is capable of improving the crude-oil pollution resistance of the drilling fluid, and allowing the drilling fluid permeated by crude coil to maintain the desirable rheological property.

In order to achieve the above objects, the first aspect of the present invention provides a viscosity reducer comprising a matrix and particles attached to the surface of the matrix and/or wrapped in the matrix, wherein the matrix comprises an oleophilic moiety and a hydrophilic moiety; the particles do not melt at 100° C. or lower; and the number of the particles in the viscosity reducer in an area of 10*10 μm is 1-1,500 according to an analysis using a scanning electron microscope.

Preferably, a ratio of the maximum absorption peak intensity (P1) in the area of 700±50 cm⁻¹ to the maximum absorption peak intensity (P2) in the area of 2920±70 cm⁻¹ in the infrared absorption spectrum of the viscosity reducer is not less than 0.25, more preferably within the range of 0.25-0.4.

The second aspect of the present invention provides a preparation method for the viscosity reducer, the preparation method comprises the following steps: mixing a matrix with particles in a molten state, and then drying the mixture; the matrix comprises an oleophilic moiety and a hydrophic moiety; the particles do not melt at 100° C. or lower, the particles have a diameter of 300 nm to 5 μm, and the mass ratio of the dosage of the matrix to the particles is 1:(0.01-0.09).

The third aspect of the present invention provides a use of the aforementioned viscosity reducer in the viscosity reduction of drilling fluid permeated by crude oil.

The fourth aspect of the present invention provides a method for improving the crude-oil pollution resistance of a drilling fluid, the method comprising adding the aforementioned viscosity reducer into the drilling fluid.

Preferably, the dosage of the viscosity reducer is 0.05-1 part by weight, more preferably 0.1-0.5 part by weight, relative to 100 parts by weight of the drilling fluid.

After the intrusion of crude oil into the oil-based drilling fluid/synthetic drilling fluid, when the temperature of the drilling fluid falls, the wax crystal in the oil phase precipitates and crystallizes, resulting in thickening of the drilling fluid, or even loss of mobility, which affects the normal circulation of the drilling fluid. The existing viscosity reducers used in the oil-based drilling fluid/synthetic drilling fluid generally achieve the viscosity reduction directed to the agglomeration of clay particles, they do not have the anti-wax effect, and cannot perform viscosity reduction for the drilling fluid permeated by the crude oil; the conventional crude oil viscosity reducers commonly used for the oil recovery of oil field, pipeline oil transportation merely consider the viscosity reduction effect in regard to crude oil, they have poor compatibility with oil-based drilling fluid/synthetic drilling fluid, and are prone to affect the electrical stability of the drilling fluid.

The viscosity reducer provided by the invention comprises a matrix and particles attached to the surface of the matrix and/or wrapped in the matrix, due to an oleophilic moiety and a hydrophilic moiety contained in the matrix, the viscosity reducer may permeate into an oil sample in the drilling fluid, and facilitate compounding of the particles and the matrix through the strong physical adsorption effect, the particles can maintain the morphology of the particles at the temperature of 100° C. or lower, and provide heterogeneous nucleation sites for wax crystals before precipitation and crystallization of the wax crystal, the particles are distribute in the oil phase in the form of micro- and nano-sized composite particles through the synergistic action of the matrix and particles, resulting in a change in the wax precipitation characteristics of the oil sample in the drilling fluid without affecting the emulsification stability of the drilling fluid, thereby allowing the wax crystals in the oil phase to form the wax crystal flocculent with a larger size and compacter structure, greatly reducing the interfacial area between the wax crystals and the oil phase, the wax crystals and the oil phase can hardly connect with each other and build the three-dimensional wax crystal network-structured wax crystal flocculent, thereby effectively preventing the viscosity increase of the drilling fluid. In a case of preferably, the viscosity reducer provided by the invention is capable of preventing the viscosity increase of the drilling fluid permeated by oil, and facilitating the improvement of electrical stability of the drilling fluid.

The viscosity reducer may be applied in the oil-based drilling fluid and/or the synthetic drilling fluid to improve the crude-oil pollution resistance of the drilling fluids, and can also be used in a drilling fluid permeated by crude oil to alleviate the thickening problems caused by the intrusion of crude oil into the drilling fluid, thereby reducing the structural viscosity of the drilling fluid and maintaining good rheological properties. The oil-soluble viscosity reducer of the present invention has the advantages such as a simple production process, low price, and free of secondary contamination.

### BRIEF DESCRIPTION OF THE DRAWINGS

FIG. 1 illustrates the ¹H NMR spectrogram of the polymer C1 prepared in Example 1 of the present invention;

FIG. 2 shows an infrared absorption spectrum of the polymer C1 prepared in Example 1 of the present invention;

FIG. 3 shows a gel permeation chromatogram of the polymer C1 prepared in Example 1 of the present invention;

FIG. 4 illustrates the scanning electron microscope (SEM) photograph of particles used in Example 1 of the present invention;

FIG. 5 shows a surface SEM photograph of the viscosity reducer prepared in Example 1 of the present invention;

FIG. 6 illustrates a cross-sectional SEM photograph of the viscosity reducer prepared in Example 1 of the present invention;

FIG. 7 shows an infrared absorption spectrum of the viscosity reducer prepared in Example 1 of the present invention.

### DESCRIPTION OF THE PREFERRED EMBODIMENT

The terminals and any value of the ranges disclosed herein are not limited to the precise ranges or values, such ranges or values shall be comprehended as comprising the values adjacent to the ranges or values. As for numerical ranges, the endpoint values of the various ranges, the endpoint values and the individual point values of the various ranges, and the individual point values may be combined with one another to produce one or more new numerical ranges, which should be deemed to have been specifically disclosed herein.

The first aspect of the present invention provides a viscosity reducer comprising a matrix and particles attached to the surface of the matrix and/or wrapped in the matrix, wherein the matrix comprises an oleophilic moiety and a hydrophilic moiety; the particles do not melt at 100° C. or lower; and the number of the particles in the viscosity reducer in an area of 10*10 μm is 1-1,500 according to an analysis using a scanning electron microscope.

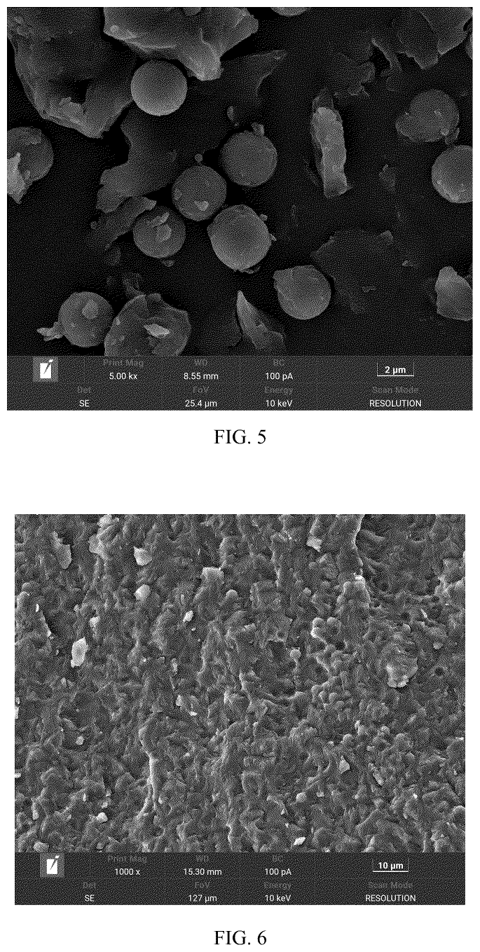

According to the present invention, the viscosity reducer comprises a matrix and particles, as shown in FIG. 5, which illustrates a surface SEM photograph of the viscosity reducer, there are particles attached to the matrix surface; as shown in FIG. 6, which illustrates a cross-sectional SEM photograph of the viscosity reducer, there may be particles wrapped in the matrix. Due to an oleophilic moiety and a hydrophilic moiety contained in the matrix, the viscosity reducer may permeate into an oil sample in the drilling fluid, and facilitate compounding of the particles and the matrix through the strong physical adsorption effect, the particles can maintain the morphology of the particles at the temperature of 100° C. or lower, and provide heterogeneous nucleation sites for wax crystals before the temperature decrease of the drilling fluid, due to the synergistic action of the matrix and particles, it causes a change in the wax precipitation characteristics of the oil sample in the drilling fluid, thereby allowing the wax crystals in the oil phase to form the wax crystal flocculent with a larger size and compacter structure, the large and compact wax crystal flocculent greatly reduce the interfacial area between the wax crystals and the oil phase, the wax crystals and the oil phase can hardly connect with each other and build the three-dimensional wax crystal network-structured wax crystal flocculent, thereby effectively preventing the viscosity increase of the drilling fluid.

In the invention, the particles in the viscosity reducer do not melt at 100° C. or lower, it can be understood that the particles in the viscosity reducer may retain their particle shape after heat treatment at any temperature below 100° C. By arranging the particles do not melt at 100° C. or lower, it can be ensured that the viscosity reducer influence the crystallization behavior of the wax crystals after the high temperature drilling fluids permeated by the crude oil have been elevated to the ground and before the wax crystals have precipitated, thereby effectively preventing the viscosity increase of the drilling fluids.

In the present invention, the particle size is preferably within the range of 300 nm-5 μm, more preferably within the range of 500 nm-3 μm. By controlling the size of the particles to be within the range of 300 nm to 5 μm, it can be ensured that the particles provide heterogeneous nucleation sites for the wax crystals. By controlling the size of the particles to be within the preferred range, it can facilitate the existence of an interaction force with a suitable intensity between the particles and the polymer, it is conducive that the was crystals in the oil phase form the wax crystal flocculent with a larger size and compacter structure, thereby further improving the viscosity reduction effect.

In the present invention, the size of the particles in the viscosity reducer refers to the maximum straight-line distance passing through the interior of the particles. The size is measured with the following method: after a sample is prepared from the viscosity reducer, the sample is observed by the Scanning Electron Microscopy (SEM), the size values of 10 particles in the viscosity reducer are counted and an average value thereof is calculated, which is denoted as the size of the particles. The test conditions of the SEM include: the SEM instrument model TESCAN MIRA LMS, test voltage of 200 eV-30 keV, and the magnification factor of 20 k-100 k.

The morphology of the particles is not particularly limited in the invention, the particles may be spherical or non-spherical particles, preferably, the particles are spherical particles.

In the invention, the particles in the viscosity reducer have good dispersibility, the number of the particles in the viscosity reducer in an area of 10*10 μm is 1-1,500, preferably 2-1,000, more preferably 5-500 according to an analysis using a scanning electron microscope. In the case of particularly preferably, the number of the particles in the viscosity reducer in an area of 10*10 μm is 5-200. In the present invention, the number of particles in the randomly selected five areas is counted and its average value is calculated, the average value is denoted as the number of particles in the viscosity reducer. When the dispersibility of the particles is controlled to be within the above-mentioned preferred ranges, it facilitates synergistic effect of the particles and the matrix, and improves the dispersibility and viscosity reducing effect of the viscosity reducer in the drilling fluid without affecting the emulsification stability of the drilling fluid.

In the present invention, FIG. 4 illustrates the SEM photograph of the untreated particles, the surface SEM photograph and the cross-sectional SEM photograph of the viscosity reducer are shown in FIG. 5 and FIG. 6, respectively. As illustrated by FIG. 5 and FIG. 6, viscosity reducer contains particles attached to the surface of the matrix and/or wrapped in the matrix; compared with the untreated particles, the particles in the viscosity reducer substantially retain their original morphology and dimensions.

In the present invention, preferably, the particles are adsorbed to the matrix surface and/or wrapped in the matrix through the hydrogen-bond interaction to form micro- and nano-scale composite particles, a ratio of the maximum absorption peak intensity (P1) in the area of 700±50 cm⁻¹ to the maximum absorption peak intensity (P2) in the area of 2920±70 cm⁻¹ in the infrared absorption spectrum of the viscosity reducer is not less than 0.25, preferably within the range of 0.25-0.4, more preferably within the range of 0.3-0.35. The term “maximum absorption peak” refers to the absorption peak having the highest intensity in the area. When the ratio P1/P2 falls into the preferred range, it facilitates penetration of the viscosity reducer into the crude oil wax crystal matrix and performs the heterogeneous nucleation effect, thereby affecting the wax morphology and net structure, disturbing growth of the wax crystal, and producing the viscosity reduction effect, the reason may be that the hydrogen bonds are generated between the matrix and the particles, there are an interaction force with an appropriate strength between the particles and the matrix, and the heterogeneous nucleation effect is enhanced.

The infra-red analysis is performed on the synthetic viscosity reducer by using a FT-IR (Nicolet iz10, Thermol Scientific Co., USA) spectrometer. The potassium bromide (KBr) tableting method was used to prepare samples by grinding the test material with KBr (1:100 weight ratio) to form pellets, and the samples required in the experiments are placed in a Fourier infrared transform spectrometer and subjected to the test analysis.

According to some preferred embodiments of the invention, the mass ratio of the matrix to the particles is 1:(0.01-0.5), more preferably 1:(0.02-0.07), further preferably 1:(0.03-0.05).

In the invention, the mass ratio of the matrix and the particle can be measured by the density comparison method, the specific operations are as follows: measuring the density values of the matrix and the particles respectively, and fitting a linear curve of density variation with mass composition, then testing the density value of the viscosity reducer, and substituting the density of the viscosity reducer into the curve of density variation with mass composition, thereby obtaining the mass ratio of the matrix and the particles.

According to some preferred embodiments of the invention, the melting point of the particles is within the range of 100-160° C., preferably within the range of 130-160° C. The melting point as depicted in the present invention refers to the melting point at the pressure of 0.1 MPa.

Preferably, the particles have a density within the range of 1-2 g/cm³, preferably within the range of 1-1.5 g/cm³.

According to some preferred embodiments of the invention, the oleophilic degree of said particles at 20° C. is not less than 50%, more preferably within 50-70%. In a case of preferably, the oleophilic degree is conducive to improving dispersibility of the viscosity reducer in drilling fluids.

In the invention, the method for testing the oleophilic degree comprises the following steps: placing 1 g of particles in 50 mL of water at 20° C., and then dropwise adding methanol until the particles are totally wetted (the particles are totally immersed in methanol and do not float on the surface, i.e., the particles are considered as totally wetted), recording the addition amount V (mL) of methanol, and calculating the oleophilic degree=V/(50+V)×100%.

The invention has a wide selection range in regard to the composition of the particles, it is preferred that the particles may meet the aforementioned physical properties, the particles may be organic particles, inorganic oxide particles, or organic-inorganic composite particles. The organic particles may be, for example, organic polymer particles; and the organic-inorganic composite particles may be organically modified inorganic particles.

In the present invention, the hydrophilic moiety and the oleophilic moiety in the matrix may have an appropriate ratio, preferably, the matrix has a hydrophilic-oleophilic balance (HLB) value within the range of 3-5. When controlling the HLB value of the matrix to be within the preferred range described above, it is conducive to improving the dispersibility and penetrating force of the viscosity reducer in the drilling fluid. In the invention, the hydrophilic-oleophilic balance value of the matrix is measured according to the distribution coefficient method.

According to some preferred embodiments of the invention, the oleophilic moiety comprises at least one oleophilic functional group, the hydrophilic entity comprises at least one hydrophilic functional group, and the molar ratio of said oleophilic functional group to said hydrophilic functional group in the matrix is (8-90):1. In the preferred case, it is advantageous to reduce viscosity of the drilling fluid permeated by crude oil and improve electrical stability of the drilling fluid.

Preferably, the oleophilic functional group is contained in an amount of 80-95 wt %, further preferably 90-94 wt %, based on the total amount of the matrix.

In the invention, the relative contents of said hydrophilic functional groups and said oleophilic functional groups are obtained by determining the characteristic functional groups through the infrared spectroscopy, and measuring the molecular weight by liquid chromatography to determine the molecular structure, and calculating based on the numbers of hydrophilic functional groups and oleophilic functional groups in the molecular structure.

The present invention does not impose specific requirements on the matrix structure, as long as the matrix includes an oleophilic moiety and a hydrophilic moiety, preferably the matrix is a polymer having a weight average molecular weight within the range of 5,000-50,000 g/mol, more preferably within the range of 6,000-30,000 g/mol, further preferably within the range of 8,000-20,000 g/mol. In the present invention, the weight average molecular weight of the polymer is determined by using the HLC-8321GPC-type gel permeation chromatograph, and using tetrahydrofuran as the mobile phase, and regarding the polystyrene as a standard sample.

Further, the matrix may be a homopolymer or a copolymer, it can be understood when the polymer is a homopolymer, the oleophilic moiety and the hydrophilic moiety are present in the identical structural unit; when the polymer is a copolymer, the oleophilic moiety and the hydrophilic moiety may be present in the identical structural unit, or may be present in different structural units. Preferably, when the polymer is a copolymer, the oleophilic moiety and the hydrophilic moiety are present in different structural units.

The present invention does not impose the specific requirement on the arrangement mode of the different structural units in the copolymer, which may be a random copolymer, an alternating copolymer or a block copolymer.

According to the invention, the oleophilic moiety comprises at least one oleophilic functional group, which facilitates penetration of the viscosity reducer into the crude oil wax crystal matrix, thereby affecting the wax precipitation characteristics of an oil sample in the drilling fluid and improving the viscosity-reducing effect. The oleophilic functional group has the conventional definition in the art, for example, it may be substituted or unsubstituted alkyl, alkenyl, alkynyl or aryl, preferably C16-C22 alkyl, alkenyl, alkynyl, or aryl, such as hexadecyl, octadecyl, eicosyl, docosyl, hexadecenyl, octadecenyl, eicosenyl, dodecadienyl, hexadecynyl, octadecynyl, eicosynyl, docosynyl, decylphenyl, undecylphenyl, dodecylphenyl, tridecylphenyl, tetradecylphenyl or hexadecylphenyl, or an isomer of the aforementioned substituents.

According to a particularly preferred embodiment of the invention, the oleophilic functional group is C16-C22 straight chain alkyl, such as hexadecyl, octadecyl, eicosyl or dococyl. In the case of preferably, the oleophilic moiety has a better matching effect with the alkyl chain length of the wax crystal, which is advantageous for further increasing the crude-oil permeation resistance of the drilling fluid and improving the viscosity reduction effect.

According to the invention, the hydrophilic moiety comprises at least one hydrophilic functional group which, on the one hand, facilitates hydrogen bond adsorption effect formed between the matrix and the particles, on the other hand, the presence of the hydrophilic functional group may prevent further aggregation of wax crystal flocculent precipitated with particles attached to the polymer surface as the crystallization templates, so that the drilling fluid retains desirable rheological properties.

In the present invention, the hydrophilic functional groups have a conventional definition in the field, for example, it may be hydroxyl, aldehyde, carboxyl, anhydride, amino, sulfonyl, sulfamido or carbamoyl, preferably at least one of hydroxyl, carboxyl, anhydride and amino. In the invention, the presence of the oleophilic functional group and the hydrophilic functional groups in the matrix may be determined by the infrared absorption spectroscopy.

According to some preferred embodiments of the invention, the matrix and the particles comprise the identical structural unit; preferably, the identical structural unit is acrylic structural element; preferably, the ratio of the molar amount of said identical structural unit contained in the matrix to the molar amount of said identical structural unit contained in the particles in the viscosity reducer is 1-30:1, more preferably 5-15:1.

According to some particularly preferred embodiments of the present invention, the polymer comprises a structural unit A represented by formula (1) and a structural unit B represented by formula (2);

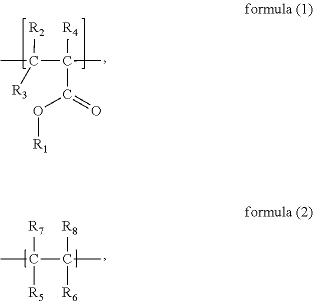

wherein R₁, R₂, R₃ and R₄ are each independently selected from hydrogen atom, C16-C22 alkyl, C16-C22 alkenyl, C16-C22 alkynyl or C16-C22 aryl group, and at least one of R₁, R₂, R₃ and R₄ is not hydrogen atom;
R₅, R₆, R₇ and R₈ comprise at least one hydroxyl, carboxyl or amino, or R₅ and R₆ are connected to form an acid anhydride, or R₇ and R₈ are connected to form an acid anhydride.

When the polymer in the viscosity reducer has the preferred structural composition described above, it is conducive to further improving the ability of the drilling fluid resisting intrusion of crude oil, and maintaining the excellent rheological properties of the drilling fluid.

Preferably, R₁ in formula (1) is selected from C16-C22 alkyl, C16-C22 alkenyl, C16-C22 alkynyl or C16-C22 aryl, more preferably C16-C22 straight chain alkyl, such as hexadecyl, octadecyl, eicosyl, docosyl, hexadecenyl, octadecenyl, eicosenyl, dodecadienyl, hexadecynyl, octadecynyl, eicosynyl, docosynyl, decylphenyl, undecylphenyl, dodecylphenyl, tridecylphenyl, tetradecylphenyl or hexadecylphenyl, or an isomer of the aforementioned substituents; R₂, R₃ and R₄ are each hydrogen.

Preferably in formula (2), R₅ and R₆ are connected to form an acid anhydride, R₇ and R₈ are hydrogen atoms; or R₇ and R₈ are connected to form an acid anhydride, R₅ and R₆ are hydrogen atoms.

According to the invention, as long as the polymer comprises the above-mentioned structural unit A and structural unit B, the invention has the wide selection ranges with respect to the relative contents of structural unit A and structural unit B to satisfy that the matrix has an appropriate hydrophilicity-lipophilicity. In order to ensure a suitable adhesive force between the polymer and the particles, and allow the viscosity reducer to desirably perform the viscosity reduction effect, the molar ratio of the structural unit A and the structural unit B in the polymer is (1-10): 1, more preferably (2-5): 1, further preferably (3-4): 1.

The invention does not impose the specific limitations to the structure of said polymer, when the polymer comprises the structural unit A and the structural unit B, there is no specific requirement on the arrangement of the structural units A and B, the polymer may be a regular block copolymer, a partially regular block copolymer or a random copolymer. For the sake of avoiding the complicated manufacturing process, the polymer of the invention is preferably a random copolymer.

In a further preferred embodiment, the particles are at least one of polymethyl methacrylate particles, polyethyl methacrylate particles, glycidyl methacrylate particles and polyethylene terephthalate particles, more preferably polymethyl methacrylate particles.

Preferably, the polymethyl methacrylate has a weight average molecular weight within the range of 15,000-750,000 g/mol, preferably 20,000-300,000 g/mol.

According to some preferred embodiments of the invention, the polymer may be prepared with the following method: mixing a monomer a with the structure represented by formula (i) and a monomer b with the structure represented by formula (ii) with a solvent, and then carrying out the copolymerization reaction under the action of an initiator;

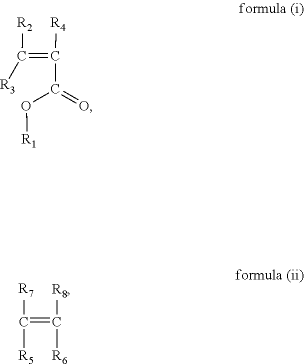

R₁-R₈ in formula (i) and formula (ii) have the same definitions as those in formula (1) and formula (2).

Preferably, the molar ratio of dosage of the monomer a to the monomer b is (1-10): 1, more preferably (2-5):1, further preferably (3-4): 1.

The invention has a wide range of choices for the initiator, any initiator known in the art that can initiate copolymerization of monomer a and monomer b may be used in the invention. Preferably, the initiator is a benzoyl peroxide.

The dosage of said initiator is not particularly limited in the invention, it can be adjusted by those skilled in the art according to the practical needs. Preferably, the dosage of said initiator is 0.3-1 wt %, more preferably 0.3-0.5 wt %, based on the total mass of the monomer a and the monomer b.

According to the invention, the copolymerization reaction is performed in the presence of a solvent, and the present invention does not impose specific requirements on the selection and dosage of the solvent, as long as it satisfies the sufficient dissolution and dispersion of the reaction raw materials. The solvent may be, for example, an alkane, a haloalkane, an aromatic hydrocarbon, a haloaromatic hydrocarbon, such as benzene, toluene, xylene, pentane, hexane, octane, cyclohexane, chlorobenzene, dichlorobenzene, and dichloromethane; preferably, the solvent is toluene. Preferably, the ratio of the mass of the solvent to the total mass of the monomer a and the monomer b is (2-7):1.

The present invention does not impose the specific requirements on the mixing mode and conditions thereof, preferably, the mixing is performed under stirring conditions. The invention does not specifically define the stirring parameters either, as long as the monomers are completely dissolved in the solvent. Preferably, the stirring rate is within the range of 400-600 rpm.

Preferably, the mixing temperature is within the range of 30-60° C., more preferably within the range of 40-50° C., and the mixing time is within the range of 5-20 min, more preferably within the range of 10-15 min. Under the preferred mixing conditions, it is advantageous to ensure complete dissolution of the monomers.

According to some preferred embodiments of the invention, the copolymerization reaction conditions comprise: a reaction temperature within the range of 50-100° C., more preferably within the range of 60-80° C., and a reaction time within the range of 2-12 hours, more preferably within the range of 5-10 hours.

According to some preferred embodiments of the invention, the preparation method comprises the following steps: mixing a monomer a with a structure represented by formula (i) and a monomers b with a structure represented by formula (ii) with a solvent, and then raising the temperature to the copolymerization reaction temperature, further adding an initiator to carry out the copolymerization reaction.

Preferably, the copolymerization reaction is performed under the stirring conditions, and the stirring conditions may be the same as the stirring conditions in the mixing process.

According to the present invention, preferably, the preparation method further comprises: purifying the product of the copolymerization reaction. The purification may be performed with the conventional process in the field, for example, it may be an organic solvent flushing and purification method; preferably the organic solvent flushing and purification process comprises: mixing the copolymerization reaction product with a solvent, stirring until a precipitation is generated, and then performing a solid-liquid separation.

In the present invention, the organic solvent may be selected from alcohols, such as methanol and/or ethanol. The present invention does not impose the specific requirements on the dosage of the organic solvent, preferably in excess of the reaction product, for instance, the amount of the organic solvent may be 5-10 times by mass of the reaction product.

The solid-liquid separation mode is not particularly limited in the invention, it may be a conventional operation mode in the field, for example, it may be filtering.

The present invention provides a viscosity reducer, the oil-soluble viscosity reducer comprises a copolymer represented by formula I and PMMA microspheres;

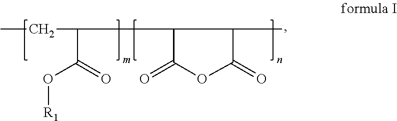

wherein R₁ is C12-C30 straight-chain or branched alkyl; m is from 10 to 50, n is from 5 to 30; the PMMA microspheres have a diameter of 300-500 nm and a crosslinking degree of 10-20%.

Preferably, R₁ in formula I is C16-C22 straight-chain or branched alkyl; and/or the ratio of m/n is (1-10):1. For example, the ratio of m/n is, but not limited to, 1:1, 2:1, 3:1, 5:1, 7:1, 8:1, 9:1, 10:1.

Preferably, the copolymer has a structure represented by formula II,

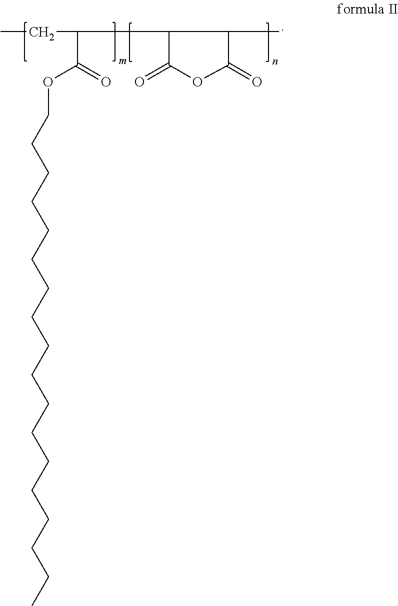

Preferably, the copolymer has a weight average molecular weight within the range of 5,000-50,000 g/mol, more preferably within the range of 8,000-30,000 g/mol, further preferably within the range of 8,000-20,000 g/mol.

Preferably, the copolymer is a random copolymer.

Preferably, the mass ratio of the copolymer to the PMMA microspheres is 1:(0.01-0.1). For example, the mass ratio of the copolymer to the PMMA microspheres is, but not limited to, 1:0.01, 1:0.03, 1:0.05, 1:0.07, 1:0.09, 1:0.1.

The second aspect of the present invention provides a preparation method for the viscosity reducer, the preparation method comprises the following steps: mixing a matrix with particles in a molten state, and then drying the mixture; the matrix comprises an oleophilic moiety and a hydrophic moiety; the particles do not melt at 100° C. or lower, and the mass ratio of the dosage of the matrix to the particles is 1:(0.01-0.5).

The matrix and the particles have the same definition as those in the first aspect, the content is not repeatedly described herein.

It is ensured in the invention that the mixing of the matrix is performed in the molten state, and at least a portion of the particles does not melt. The preferred mixing mode can advantageously increase dispersity of the particles, provides a suitable interaction force between the matrix and the particles, and further improve the viscosity reduction effect of the viscosity reducer. In the present invention, the matrix may be initially melted and then mixed with the particles, or the matrix and particles may be initially mixed and then heated to melt the matrix. Preferably, the matrix and particles are added into a mixing equipment for performing the melt blending.

In the present invention, the mixing may be carried out by using a conventional equipment in the field, for example, the mixing is performed in a melt blender.

According to some preferred embodiments of the invention, the mixing conditions comprise: the mixing temperature within the range of 100-180° C., more preferably within the range of 120-160° C., and the mixing time within the range of 5-30 min, preferably within the range of 10-20 min.

Preferably, the mass ratio of the dosage of the matrix to the particles is 1:(0.02-0.07), more preferably 1:(0.03-0.05).

Preferably, the drying is carried out under vacuum condition, the drying temperature is within the range of 50-100° C., more preferably within the range of 60-80° C., and the time is within the range of 5-15 h, preferably within the range of 10-12 h.

The third aspect of the present invention provides a use of the aforementioned viscosity reducer in the viscosity reduction of drilling fluid permeated by crude oil.

The fourth aspect of the present invention provides a method for improving the crude-oil pollution resistance of a drilling fluid, the method comprising adding the viscosity reducer according to the first aspect into the drilling fluid.

In the invention, the viscosity reducer may be added into the drilling fluid which has not been permeated by crude oil, or may be added into the drilling fluid during its use process and after permeation by the crude oil, in order to improve the crude-oil pollution resistance of the drilling fluid and inhibit the viscosity increase of the drilling fluid after permeation by the crude oil. Since the permeation of crude oil into the drilling fluid is typically performed in the underground and high-temperature environments, after the drilling fluid is circulated to the surface, crude oil wax precipitates and crystallizes along with the temperature decrease, resulting in the increased viscosity, poor fluidity, or even loss of mobility of the drilling fluid, which affects the normal circulation and reuse of the drilling fluid. The viscosity reducer provided by the present invention may preferably be added into the drilling fluid after permeation of crude oil into the drilling fluid, and before precipitation and crystallization of the crude oil wax, i.e., the viscosity reducer is added into the drilling fluid after elevating the drilling fluid to the ground surface and before the drilling fluid has been cooled, such that the wax crystals in the oil phase may precipitate by using the particles attached to the polymer surface as the crystallization templates, thereby forming the wax crystal flocculent with a large size and a compact structure, and avoiding the problem of deterioration of overall rheological properties resulting from the permeation of the crude oil into the drilling fluid.

According to some preferred embodiments of the present invention, the dosage of the viscosity reducer is 0.05-1 part by weight, more preferably 0.1-0.5 part by weight, relative to 100 parts by weight of the drilling fluid.

The composition of the drilling fluid is not specifically limited in the invention, the drilling fluid may be an oil-based drilling fluid or a synthetic drilling fluid commonly used in the field.

In the present invention, the kind of base oil in the oil-based drilling fluid or synthetic drilling fluid may be selected from wide ranges, the base oil can be provided by oil phases conventionally used in the field, and it can be selected by those skilled in the art according to actual requirements. Preferably, the base oil is at least one selected from the group consisting of mineral oils and artificially synthetic base oils, which are well-known among those skilled in the art.

According to the invention, the drilling fluid may further comprise one or more of drilling fluid treatment agents conventional in the field, such as an organic soil, an emulsifier, an inhibitor, a plugging agent, a weighting agent, a wetting agent, an alkaline regulator and a filtrate reducer. Those skilled in the art may choose the treatment agents according to the actual needs, the types of treatment agents are not specifically limited in the invention. According to some preferred embodiments of the invention, for example, the organic soil may be a quaternary ammonium salt-modified bentonite.

The present invention does not specifically limit the source of the filtrate reducer, which may be the commercially available product well-known among those skilled in the art. For example, the filtrate reducer may be a humic acid type filtrate reducer, an asphalt-based filtrate reducer. For instance, the filtrate reducer may be natural asphalt powder purchased from Shengli Oilfield Zhongsheng Petrochemical Co., Ltd.

According to some preferred embodiments of the invention, the emulsifier may be at least one selected from the group consisting of a divalent metal soap of advanced fatty acids, calcium alkyl sulfonates, fatty acid emulsifiers and amide-based emulsifiers. Preferably, the emulsifier comprises a main emulsifier and an auxiliary emulsifier, which may be collocated in a conventional mode in the field. Preferably, the dosage ratio by mass of the main emulsifier to the auxiliary emulsifier is 1:0.3-1.

The present invention does not impose specific requirements on the selection of the main emulsifier and the auxiliary emulsifier, those skilled in the art may select it according to practical needs. For example, the main emulsifier may be a commercial product purchased from Jingzhou Jiahua Technology Co., Ltd. With the product name HIEMUL, and the auxiliary emulsifier may be a commercial product purchased from Jingzhou Jiahua Technology Co., Ltd. With the product name HICOAT.

According to some preferred embodiments of the present invention, the weighting agent may be barite and/or iron ore powder, preferably barite. The invention does not impose specific requirements on the dosage of the weighting agent, the dosage may be adjusted according to the drilling fluid density.

According to some preferred embodiments of the invention, the alkaline regulator may be calcium oxide.

According to some preferred embodiments of the invention, the wetting agent may be a long-chain alkane quaternary ammonium organic substance. For example, the wetting agent may be a commercial product purchased from Jingzhou Jiahua Technology Co., Ltd. with the product name HIWET.

The dosages of said emulsifier, wetting agent, filtrate reducer, alkaline regulator and organic soil may be selected according to practical needs, the present invention does not impose particular limitations thereto. According to some preferred embodiments of the invention, the main emulsifier is used in an amount of 1-4 parts by weight, the auxiliary emulsifier is used in an amount of 1-2 parts by weight, the wetting agent is used in an amount of 0.5-2 parts by weight, the filtrate reducer is used in an amount of 1-5 parts by weight, the alkaline regulator is used in an amount of 1-5 parts by weight, and the organic soil is used in an amount of 1-6 parts by weight, based on 100 parts by weight of the base oil.

The invention will be described in detail below with reference to examples.

The main raw materials involved in the following examples and comparative examples were as follows, all the remaining raw materials were commercially available unless otherwise specified in the invention.

Polymethyl methacrylate (PMMA) microspheres P1: commercially available microspheres with a diameter of 400 nm, a density within the range of 1-1.3 g/cm³, and a weight average molecular weight of 40,000 g/mol, and PMMA microspheres P1 had a lipophilicity degree of 65% under the temperature of 20° C.;
Polymethyl methacrylate (PMMA) microspheres P2: commercially available microspheres with a diameter of 3 μm, a density within the range of 1.1-1.3 g/cm³, and a weight average molecular weight of 250,000 g/mol, and PMMA microspheres P2 had a lipophilicity degree of 50% under the temperature of 20° C.;
Main emulsifier: with a product name HIEMUL, purchased from Jingzhou Jiahua Technology Co., Ltd.;
Auxiliary emulsifier: with a product name HICOAT, purchased from Jingzhou Jiahua Technology Co., Ltd.;
Organic soil: with a product name FBJS-147, purchased from Zhejiang Fenghong New Material Co., Ltd.;
Wetting agent: with a product name HIWET, purchased from Jingzhou Jiahua Technology Co., Ltd.;
Filtrate reducer: natural asphalt powder, purchased from Shengli Oilfield Zhongsheng Petrochemical Co., Ltd.;
Alkaline regulator: with a product name LIM, purchased from Jingzhou Jiahua Technology Co., Ltd.;
Barite: commercially available from Shengli Oilfield Wantai Industry and Trade Co., Ltd.

The specific conditions of the main tests involved in the Examples and Comparative Examples below were as follows:

The nuclear magnetic resonance hydrogen spectrum (¹H NMR) of the polymer was tested at 500 MHz by using the Bruker-500 AVANCE III HD nuclear magnetic resonance spectrometer manufactured by Bruker Corporation of Switzerland, the solvent was deuterated chloroform.

The synthetic oil-soluble viscosity reducer was subjected to infrared analysis by using FT-IR spectrometer (Nicolet iz10, Thermol Scientific Co., USA). The product to be tested and KBr (1:100) were milled and tableted by using the KBr tableting method, the sample required by the experiment was placed in a Fourier Transform Spectrometer for test analysis.

The weight average molecular weight of the polymer was measured with a HLC-8321 GPC Gel Permeation Chromatograph by using tetrahydrofuran as the mobile phase and polystyrene as the standard sample.

### Example 1

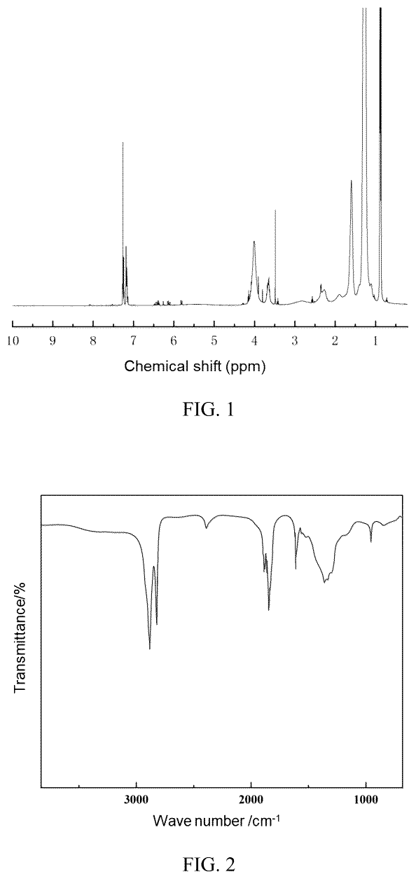

(1) Octadecyl acrylate and maleic anhydride monomers were weighed according to the molar ratio of 3:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C1; the composition and structure of polymer C1 were analyzed by nuclear magnetic hydrogen spectroscopy analysis, as shown by FIG. 1, the hydrogen proton peaks at chemical shifts of δ0.9, δ1.3 and δ1.6 belonged to the hydrogen proton peaks of —CH₃, —CH₂— and —CH—, respectively, the hydrogen proton peak at the chemical shift of δ4.0 was the hydrogen proton peak of —C═O—CH₂—, the hydrogen proton peak at the chemical shift of δ3.5 was the hydrogen proton peak attributed to the maleic anhydride group. The infrared absorption spectrum of polymer C1 was shown in FIG. 2, the characteristic spectral bands were shown at the wave numbers 1470 cm⁻¹, 2920 cm⁻¹ (—CH₂— stretching peak), 2960 cm⁻¹ (—CH₃ stretching peak) and 1740 cm⁻¹ (C═O ester group stretching peak), C═O characteristic peaks of the anhydride group appeared at the wave numbers 1785 cm⁻¹ and 1851 cm⁻¹, and the characteristic peak was not shown at the wave number 1600-1680 cm⁻¹, it indicated the absence of —C═C—, it demonstrated that the copolymerization reaction of the acrylate monomers with the maleic anhydride was performed. It proved the successful synthesis of octadecyl acrylate-maleic anhydride copolymer.

It was demonstrated based on the combined results of nuclear magnetism and infrared, the polymer C1 comprised a structural unit A represented by formula (1) and a structural unit B represented by formula (2), wherein R₁ was C18 straight chain alkyl; R₂, R₃, R₄ were hydrogen atoms, R₅ and R₆ were connected to form an acid anhydride, R₇ and R₈ were hydrogen.

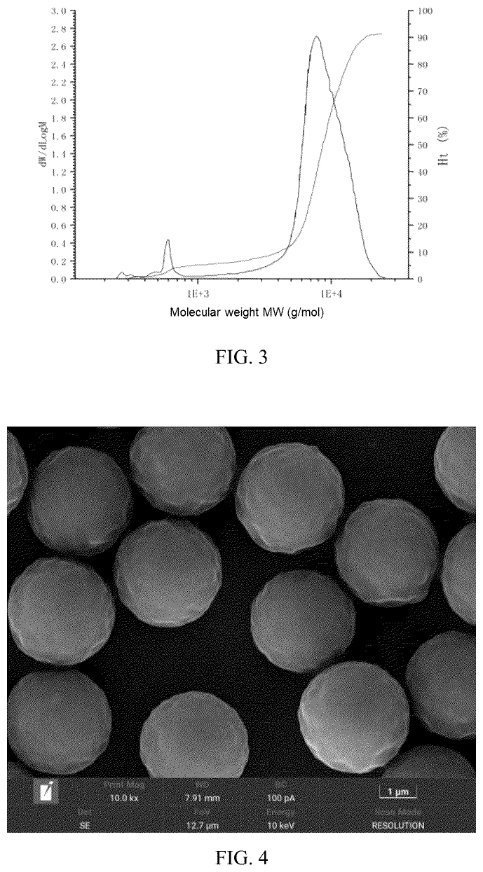

The characterization by GPC assay was shown in FIG. 3, the weight average molecular weight of the polymer C1 was calculated as 11,886 g/mol. The matrix had a hydrophilic-oleophilic balance value (HLB value) of 4.5, as measured by the distribution coefficient method.
(3) Polymer C1 and PMMA microspheres P2 in a mass ratio of 1:0.03 were placed in a melt blender, and melt blended at 130° C. for 17 min, a blend was obtained;
(4) The blend obtained in step (3) was placed in a vacuum oven and dried at 80° C. in vacuum for 12 h to obtain a white block product, namely an oil-soluble viscosity reducer S1. In the viscosity reducer, both the matrix and the microspheres contained acrylic structural units, and the molar ratio of acrylic structural units from the matrix to acrylic structural units from the microspheres was 9.3:1.

The SEM photograph of untreated microspheres was shown in FIG. 4, the surface SEM photograph and the cross-sectional SEM photograph of the viscosity reducer S1 were shown in FIG. 5 and FIG. 6, respectively. As illustrated by FIG. 5 and FIG. 6, the viscosity reducer comprised particles attached to the surface of the matrix and/or wrapped in the matrix, and the microspheres in the viscosity reducer substantially retained their original morphology and dimensions. The number of the particles in the viscosity reducer in an area of 10*10 μm was 5 according to an analysis using a scanning electron microscope.

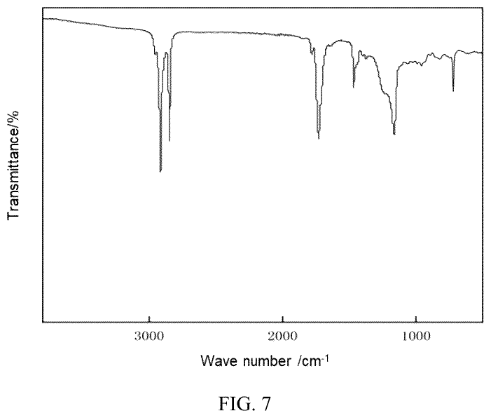

The viscosity reducer S1 was subjected to the infrared absorption spectrum test, the results were shown in FIG. 7, compared with the infrared absorption spectrum of polymer C1, the maximum absorption Peak Intensity (P1) at the wave number of 705 cm⁻¹ was significantly enhanced, it indicated that the PMMA microspheres were combined with the polymer through hydrogen bonding.

A ratio of the maximum absorption peak intensity (P1) at 705 cm⁻¹ to the maximum absorption peak intensity (P2) at 2915 cm⁻¹ in the infrared absorption spectrum of the viscosity reducer was 0.3.

### Example 2

The viscosity reducer was prepared according to the method in Example 1, except that polymer C1 and PMMA microspheres P1 in a mass ratio of 1:0.05 were placed in a melt blender, and melt blended at 130° C. for 11 min, a blend was obtained; the blend was placed in a vacuum oven and dried at 80° C. in vacuum for 12 h to obtain a white block product, namely an oil-soluble viscosity reducer S2. In the viscosity reducer, both the matrix and the microspheres contained acrylic structural units, and the molar ratio of acrylic structural units from the matrix to acrylic structural units from the microspheres was 5.6:1.

The viscosity reducer S2 was subjected to the scanning electron microscopy characterization, the results were similar with those of FIG. 5 and FIG. 6, the number of the particles in the viscosity reducer in an area of 10*10 μm was 28 according to an analysis using a scanning electron microscope.

The viscosity reducer S2 was subjected to the infrared absorption spectrum test, a ratio of the maximum absorption peak intensity (P1) at 705 cm⁻¹ to the maximum absorption peak intensity (P2) at 2915 cm⁻¹ in the infrared absorption spectrum of the viscosity reducer was 0.35.

### Example 3

(1) Hexadecyl acrylate and maleic anhydride monomers were weighed according to the molar ratio of 3:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C2; the composition and structure of polymer C2 were analyzed by nuclear magnetic hydrogen spectroscopy analysis, the peaks are attributed as follows: ¹H NMR, the absorption peaks at different chemical shifts represented different types of hydrogen protons. The hydrogen proton peaks at chemical shifts of δ0.9, δ1.3 and δ1.6 belonged to the hydrogen proton peaks of —CH₃, —CH₂— and —CH—, respectively, the hydrogen proton peak at the chemical shift of δ4.0 was the hydrogen proton peak of —C═O—CH₂—, the hydrogen proton peak at the chemical shift of δ3.5 was the hydrogen proton peak attributed to the maleic anhydride group. That is, the hydrogen proton peak at the chemical shift of δ3.5 demonstrated the successful synthesis of the polymer C2.

It was demonstrated that the polymer C2 comprised a structural unit A represented by formula (1) and a structural unit B represented by formula (2), wherein R₁ was C16 straight chain alkyl; R₂, R₃, R₄ were hydrogen atoms, R₅ and R₆ were connected to form an acid anhydride, R₇ and R₈ were hydrogen.

The characterization by GPC assay showed that the weight average molecular weight of the polymer C2 was 10,940 g/mol. The polymer C2 had a hydrophilic-oleophilic balance value (HLB value) of 4.6, as measured by the distribution coefficient method.
(3) Polymer C2 and PMMA microspheres P1 in a mass ratio of 1:0.05 were placed in a melt blender, and melt blended at 130° C. for 17 min, a blend was obtained;
(4) The blend obtained in step (3) was placed in a vacuum oven and dried at 80° C. in vacuum for 12 h to obtain a white block product, namely an oil-soluble viscosity reducer S3. In the viscosity reducer, both the matrix and the microspheres contained acrylic structural units, and the molar ratio of acrylic structural units from the matrix to acrylic structural units from the microspheres was 6:1.

The viscosity reducer S3 was subjected to the scanning electron microscopy characterization, the results were similar with those of FIG. 5 and FIG. 6, the number of the particles in the viscosity reducer in an area of 10*10 μm was 25 according to an analysis using a scanning electron microscope.

The viscosity reducer S3 was subjected to the infrared absorption spectrum test, compared with the infrared absorption spectrum of polymer C2, the maximum absorption Peak Intensity (P1) of the viscosity reducer at the wave number of 691 cm⁻¹ was obviously enhanced, it indicated that the PMMA microspheres were combined with the polymer through hydrogen bonding.

A ratio of the maximum absorption peak intensity (P1) at 691 cm⁻¹ to the maximum absorption peak intensity (P2) at 2849 cm⁻¹ in the infrared absorption spectrum of the viscosity reducer was 0.34.

### Example 4

(1) Octadecyl acrylate and maleic anhydride monomers were weighed according to the molar ratio of 2:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C3; the composition and structure of polymer C3 were analyzed by nuclear magnetic hydrogen spectroscopy analysis, the peaks are attributed as follows: ¹H NMR, the hydrogen proton peaks at chemical shifts of δ0.9, δ1.3 and δ1.6 belonged to the hydrogen proton peaks of —CH₃, —CH₂— and —CH—, respectively, but the intensities of said absorption peaks were different from those in FIG. 1. The hydrogen proton peak at the chemical shift of δ4.0 was the hydrogen proton peak of —C═O—CH₂—, the hydrogen proton peak at the chemical shift of δ3.5 was the hydrogen proton peak attributed to the maleic anhydride group. That is, the hydrogen proton peak at the chemical shift of δ3.5 demonstrated the successful synthesis of the polymer C3.

It was demonstrated that the polymer C3 comprised a structural unit A represented by formula (1) and a structural unit B represented by formula (2), wherein R₁ was C18 straight chain alkyl; R₂, R₃, R₄ were hydrogen atoms, R₅ and R₆ were connected to form an acid anhydride, R₇ and R₈ were hydrogen.

The characterization by GPC assay showed that the weight average molecular weight of the polymer C3 was 11,192 g/mol. The polymer C3 had a hydrophilic-oleophilic balance value (HLB value) of 4.6, as measured by the distribution coefficient method.
(3) Polymer C3 and PMMA microspheres P1 in a mass ratio of 1:0.05 were placed in a melt blender, and melt blended at 160° C. for 12 min, a blend was obtained;
(4) The blend obtained in step (3) was placed in a vacuum oven and dried at 80° C. in vacuum for 12 h to obtain a white block product, namely an oil-soluble viscosity reducer S4. In the viscosity reducer, both the matrix and the microspheres contained acrylic structural units, and the molar ratio of acrylic structural units from the matrix to acrylic structural units from the microspheres was 8:1.

The viscosity reducer S4 was subjected to the scanning electron microscopy characterization, the results were similar with those of FIG. 5 and FIG. 6, the number of the particles in the viscosity reducer in an area of 10*10 μm was 27 according to an analysis using a scanning electron microscope.

The viscosity reducer S4 was subjected to the infrared absorption spectrum test, compared with the infrared absorption spectrum of polymer C3, the maximum absorption Peak Intensity (P1) of the viscosity reducer at the wave number of 700 cm⁻¹ was obviously enhanced, a ratio of the maximum absorption peak intensity (P1) at 700 cm⁻¹ to the maximum absorption peak intensity (P2) at 2920 cm⁻¹ in the infrared absorption spectrum of the viscosity reducer was 0.35.

### Example 5

(1) Octadecyl acrylate and maleic anhydride monomers were weighed according to the molar ratio of 5:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C4; the composition and structure of polymer C4 were analyzed by nuclear magnetic hydrogen spectroscopy analysis, it was demonstrated that the polymer C4 comprised a structural unit A represented by formula (1) and a structural unit B represented by formula (2), wherein R₁ was C18 straight chain alkyl; R₂, R₃, R₄ were hydrogen atoms, R₅ and R₆ were connected to form an acid anhydride, R₇ and R₈ were hydrogen.

The characterization by GPC assay showed that the weight average molecular weight of the polymer C4 was 12,030 g/mol. The polymer C4 had a hydrophilic-oleophilic balance value (HLB value) of 4.2, as measured by the distribution coefficient method.
(3) Polymer C4 and PMMA microspheres P1 in a mass ratio of 1:0.05 were placed in a melt blender, and melt blended at 160° C. for 10 min, a blend was obtained;
(4) The blend obtained in step (3) was placed in a vacuum oven and dried at 80° C. in vacuum for 12 h to obtain a white block product, namely an oil-soluble viscosity reducer S5. In the viscosity reducer, both the matrix and the microspheres contained acrylic structural units, and the molar ratio of acrylic structural units from the matrix to acrylic structural units from the microspheres was 3.4:1.

The viscosity reducer S5 was subjected to the scanning electron microscopy characterization, the results were similar with those of FIG. 5 and FIG. 6, the number of the particles in the viscosity reducer in an area of 10*10 μm was 20 according to an analysis using a scanning electron microscope.

The viscosity reducer S5 was subjected to the infrared absorption spectrum test, a ratio of the maximum absorption peak intensity (P1) at 730 cm⁻¹ to the maximum absorption peak intensity (P2) at 2960 cm⁻¹ in the infrared absorption spectrum of the viscosity reducer was 0.3.

### Example 6

The viscosity reducer was prepared according to the method in Example 2, except that polymer C1 and PMMA microspheres P1 in a mass ratio of 1:0.01 were placed in a melt blender, and melt blended at 130° C. for 14 min, a blend was obtained; the obtained blend was placed in a vacuum oven and dried at 80° C. in vacuum for 12 h to obtain a white block product, namely an oil-soluble viscosity reducer S6. In the viscosity reducer, both the matrix and the microspheres contained acrylic structural units, and the molar ratio of acrylic structural units from the matrix to acrylic structural units from the microspheres was 28:1.

The viscosity reducer S6 was subjected to the scanning electron microscopy characterization, the results were similar with those of FIG. 5 and FIG. 6, the number of the particles in the viscosity reducer in an area of 10*10 μm was 12 according to an analysis using a scanning electron microscope.

The viscosity reducer S6 was subjected to the infrared absorption spectrum test, a ratio of the maximum absorption peak intensity (P1) at 697 cm⁻¹ to the maximum absorption peak intensity (P2) at 2900 cm⁻¹ in the infrared absorption spectrum of the viscosity reducer was 0.25.

### Example 7

The viscosity reducer was prepared according to the method in Example 2, except that polymer C1 and PMMA microspheres P1 in a mass ratio of 1:0.07 were placed in a melt blender, and melt blended at 140° C. for 16 min, a blend was obtained; the obtained blend was placed in a vacuum oven and dried at 80° C. in vacuum for 12 h to obtain a white block product, namely an oil-soluble viscosity reducer S7.

The viscosity reducer S7 was subjected to the scanning electron microscopy characterization, the results were similar with those of FIG. 5 and FIG. 6, the number of the particles in the viscosity reducer in an area of 10*10 μm was 54 according to an analysis using a scanning electron microscope. In the viscosity reducer, both the matrix and the microspheres contained acrylic structural units, and the molar ratio of acrylic structural units from the matrix to acrylic structural units from the microspheres was 4:1.

The viscosity reducer S7 was subjected to the infrared absorption spectrum test, a ratio of the maximum absorption peak intensity (P1) at 730 cm⁻¹ to the maximum absorption peak intensity (P2) at 2915 cm⁻¹ in the infrared absorption spectrum of the viscosity reducer was 0.36.

### Example 8

The viscosity reducer was prepared according to the method in Example 2, except that polymer C1 and PMMA microspheres P1 in a mass ratio of 1:0.09 were placed in a melt blender, and melt blended at 140° C. for 15 min, a blend was obtained; the obtained blend was placed in a vacuum oven and dried at 80° C. in vacuum for 12 h to obtain a white block product, namely an oil-soluble viscosity reducer S7. In the viscosity reducer, both the matrix and the microspheres contained acrylic structural units, and the molar ratio of acrylic structural units from the matrix to acrylic structural units from the microspheres was 3.1:1.

The viscosity reducer S7 was subjected to the scanning electron microscopy characterization, the results were similar with those of FIG. 5 and FIG. 6, the number of the particles in the viscosity reducer in an area of 10*10 μm was 75 according to an analysis using a scanning electron microscope.

The viscosity reducer S7 was subjected to the infrared absorption spectrum test, a ratio of the maximum absorption peak intensity (P1) at 710 cm⁻¹ to the maximum absorption peak intensity (P2) at 2920 cm⁻¹ in the infrared absorption spectrum of the viscosity reducer was 0.34.

### Example 9

(1) Octadecyl acrylate and maleic anhydride monomers were weighed according to the molar ratio of 1:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C5; the composition and structure of polymer C5 were analyzed by nuclear magnetic hydrogen spectroscopy analysis, it was demonstrated that the polymer C5 comprised a structural unit A represented by formula (1) and a structural unit B represented by formula (2), wherein R₁ was C18 straight chain alkyl; R₂, R₃, R₄ were hydrogen atoms, R₅ and R₆ were connected to form an acid anhydride, R₇ and R₈ were hydrogen.

The characterization by GPC assay showed that the weight average molecular weight of the polymer C5 was 10,980 g/mol. The polymer C5 had a hydrophilic-oleophilic balance value (HLB value) of 5, as measured by the distribution coefficient method.
(3) Polymer C5 and PMMA microspheres P1 in a mass ratio of 1:0.05 were placed in a melt blender, and melt blended at 160° C. for 10 min, a blend was obtained;
(4) The blend obtained in step (3) was placed in a vacuum oven and dried at 80° C. in vacuum for 12 h to obtain a white block product, namely an oil-soluble viscosity reducer S9. In the viscosity reducer, both the matrix and the microspheres contained acrylic structural units, and the molar ratio of acrylic structural units from the matrix to acrylic structural units from the microspheres was 1.1:1.

The viscosity reducer S9 was subjected to the scanning electron microscopy characterization, the results were similar with those of FIG. 5 and FIG. 6, the number of the particles in the viscosity reducer in an area of 10*10 μm was 21 according to an analysis using a scanning electron microscope.

The viscosity reducer S9 was subjected to the infrared absorption spectrum test, a ratio of the maximum absorption peak intensity (P1) at 690 cm⁻¹ to the maximum absorption peak intensity (P2) at 2940 cm⁻¹ in the infrared absorption spectrum of the viscosity reducer was 0.36.

### Example 10

(1) Octadecyl acrylate and maleic anhydride monomers were weighed according to the molar ratio of 7:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C6; the composition and structure of polymer C6 were analyzed by nuclear magnetic hydrogen spectroscopy analysis, it was demonstrated that the polymer C6 comprised a structural unit A represented by formula (1) and a structural unit B represented by formula (2), wherein R₁ was C18 straight chain alkyl; R₂, R₃, R₄ were hydrogen atoms, R₅ and R₆ were connected to form an acid anhydride, R₇ and R₈ were hydrogen.

The characterization by GPC assay showed that the weight average molecular weight of the polymer C6 was 12,376 g/mol. The polymer C6 had a hydrophilic-oleophilic balance value (HLB value) of 3.8, as measured by the distribution coefficient method.
(3) Polymer C6 and PMMA microspheres P1 in a mass ratio of 1:0.05 were placed in a melt blender, and melt blended at 140° C. for 13 min, a blend was obtained;
(4) The blend obtained in step (3) was placed in a vacuum oven and dried at 80° C. in vacuum for 12 h to obtain a white block product, namely an oil-soluble viscosity reducer S10. In the viscosity reducer, both the matrix and the microspheres contained acrylic structural units, and the molar ratio of acrylic structural units from the matrix to acrylic structural units from the microspheres was 6:1.

The viscosity reducer S10 was subjected to the scanning electron microscopy characterization, the results were similar with those of FIG. 5 and FIG. 6, the number of the particles in the viscosity reducer in an area of 10*10 μm was 20 according to an analysis using a scanning electron microscope.

The viscosity reducer S10 was subjected to the infrared absorption spectrum test, a ratio of the maximum absorption peak intensity (P1) at 705 cm⁻¹ to the maximum absorption peak intensity (P2) at 2920 cm⁻¹ in the infrared absorption spectrum of the viscosity reducer was 0.29.

### Example 11

(1) Octadecyl acrylate and maleic anhydride monomers were weighed according to the molar ratio of 10:1 and added into a flask, and a toluene solvent was added with a ratio of toluene to the total mass of the monomers being 3:1, the temperature of the oil bath was controlled to be 40° C. and the mechanical stirring at a constant rate was applied, the stirring rate was maintained at 500 rpm, after stirring for 10 min to ensure complete dissolution of the monomers in toluene, the temperature of the oil bath was raised to the reaction temperature of 80° C., and the benzoyl peroxide (1 wt % of the mass of the monomers) solution was dropwise added, the reaction time was controlled to be 8 h, the reaction product was obtained;
(2) The reaction product obtained from step (1) was poured into a 500 mL beaker, 5 times by mass of methanol was added and stirred continuously till the flocculent precipitate appeared at the bottom of the beaker, the flocculent precipitate was filtered and dried to obtain a purified polymer C7; the composition and structure of polymer C7 were analyzed by nuclear magnetic hydrogen spectroscopy analysis, it was demonstrated that the polymer C7 comprised a structural unit A represented by formula (1) and a structural unit B represented by formula (2), wherein R₁ was C18 straight chain alkyl; R₂, R₃, R₄ were hydrogen atoms, R₅ and R₆ were connected to form an acid anhydride, R₇ and R₈ were hydrogen.

The characterization by GPC assay showed that the weight average molecular weight of the polymer C7 was 16,698 g/mol. The polymer C7 had a hydrophilic-oleophilic balance value (HLB value) of 3.2, as measured by the distribution coefficient method.
(3) Polymer C7 and PMMA microspheres P1 in a mass ratio of 1:0.05 were placed in a melt blender, and melt blended at 150° C. for 15 min, a blend was obtained;
(4) The blend obtained in step (3) was placed in a vacuum oven and dried at 80° C. in vacuum for 12 h to obtain a white block product, namely an oil-soluble viscosity reducer S11. In the viscosity reducer, both the matrix and the microspheres contained acrylic structural units, and the molar ratio of acrylic structural units from the matrix to acrylic structural units from the microspheres was 6:1.

The viscosity reducer S11 was subjected to the scanning electron microscopy characterization, the results were similar with those of FIG. 5 and FIG. 6, the number of the particles in the viscosity reducer in an area of 10*10 μm was 18 according to an analysis using a scanning electron microscope.

The viscosity reducer S11 was subjected to the infrared absorption spectrum test, a ratio of the maximum absorption peak intensity (P1) at 740 cm⁻¹ to the maximum absorption peak intensity (P2) at 2920 cm⁻¹ in the infrared absorption spectrum of the viscosity reducer was 0.21.

### Example 12

The viscosity reducer was prepared according to the method in Example 2, except that polymer C1 and PMMA microspheres P1 in a mass ratio of 1:0.05 were mixed directly at normal temperature for 17 min, a mixture viscosity reducer S12 was obtained.

The viscosity reducer S13 was subjected to the scanning electron microscopy characterization, microspheres were attached to the surface of the polymer, the dispersion uniformity was poor, the number of the particles in the viscosity reducer in an area of 10*10 μm was 32 according to an analysis using a scanning electron microscope.

The viscosity reducer S1 was subjected to the infrared absorption spectrum test, a ratio of the maximum absorption peak intensity (P1) at 700 cm⁻¹ to the maximum absorption peak intensity (P2) at 2920 cm⁻¹ in the infrared absorption spectrum of the viscosity reducer was 0.12.

### Example 13

The viscosity reducer was prepared according to the method in Example 2, except that polymer C1 and PMMA microspheres P1 in a mass ratio of 1:0.5 were placed in a melt blender, and melt blended at 140° C. for 15 min, a blend was obtained; the obtained blend was placed in a vacuum oven and dried at 80° C. in vacuum for 12 h to obtain a white block product, namely an oil-soluble viscosity reducer S13. In the viscosity reducer, both the matrix and the microspheres contained acrylic structural units, and the molar ratio of acrylic structural units from the matrix to acrylic structural units from the microspheres was 0.6:1.

The viscosity reducer S13 was subjected to the scanning electron microscopy characterization, the results were similar with those of FIG. 5 and FIG. 6, the number of the particles in the viscosity reducer in an area of 10*10 μm was 510 according to an analysis using a scanning electron microscope.

The viscosity reducer S13 was subjected to the infrared absorption spectrum test, a ratio of the maximum absorption peak intensity (P1) at 710 cm⁻¹ to the maximum absorption peak intensity (P2) at 2920 cm⁻¹ in the infrared absorption spectrum of the viscosity reducer was 0.5.

### Comparative Example 1

Octadecyl polyacrylate (with a weight average molecular weight of 7,000 g/mol) and PMMA microsphere P1 in the mass ratio of 1:0.05 were placed in a melt blender, and melt blended at 130° C. for 17 min, a blend was obtained;
The blend was then placed in a vacuum oven and dried at 80° C. in vacuum for 12 h, a viscosity reducer DS1 was obtained.

### Comparative Example 2

A silicon fluoride-based viscosity reducer (purchased from Shandong Jiaozhou Petroleum Additives Co., Ltd.) was used as the viscosity reducer DS2.

### Comparative Example 3

PMMA microspheres P1 were used directly as the viscosity reducer, which was denoted as DS3.

### Comparative Example 4

The polymer C7 obtained in Example 11 was directly used as the viscosity reducer, which was denoted as DS4.

### Test Example

### Preparation of the drilling fluid

Preparation of a synthetic drilling fluid: 240 g of continuous phase base oil was taken, 9 g of a main emulsifier and 3 g of an auxiliary emulsifier were added, stirred at high speed for 60 minutes to fully dissolve the materials, 60 g of an aqueous calcium chloride solution was added, stirred at high speed for 60 minutes to form a water-in-oil emulsion; 12 g of an organic soil, 3 g of a wetting agent, 10 g of a filtrate reducer and 6 g of an alkaline regulator were further added, stirred for 20 minutes to fully dissolve the materials, barite was added to increase the weight until the density reached 1.8 g/cm³, and stirred for 60 minutes, a synthetic drilling fluid was prepared.
(1) Use to illustrate the performance of viscosity reducers in improving the resistance of drilling fluid to the crude oil permeation

The viscosity reducers obtained in the above Examples and Comparative Examples were added into the synthetic drilling fluid, the dosing amounts of the viscosity reducers based on 100 parts by weight of the drilling fluid were shown in Table 1. 20 wt % of crude oil was then added into the synthetic drilling fluid respectively, wherein the crude oil was the crude oil derived from E₂S³ horizon of Cenozoic Paleogene system in Jiyang Depression; the apparent viscosity, the dynamic shear force and the demulsification voltage of the drilling fluids were tested at the temperature of 20° C. according to the China National Standard GB/T 16783.2-2012 “Petroleum and natural gas industries—Field testing of drilling fluids—Part 2: Oil-based fluids”, the results were shown in Table 1.

TABLE 1

| | Dosing amount | | | Demulsifi- |
|---|---|---|---|---|
| | of viscosity | Apparent | Dynamic shear | cation |
| Viscosity | reducer | viscosity | force | voltage |
| reducers | (part by weight) | mPa · s | Pa | V |
| Non-polluted drilling fluid | | 79 | 18 | 1084 |
| S1 | 0.1 | 93 | 24 | 1482 |
| S2 | 0.5 | 95 | 25 | 1656 |
| S3 | 0.2 | 95 | 25 | 1570 |
| S1 | 1 | 100 | 31 | 1920 |
| S4 | 0.1 | 98 | 27 | 1416 |
| S5 | 0.1 | 97 | 27 | 1509 |
| S6 | 0.1 | 98 | 27 | 1480 |
| S7 | 0.1 | 98 | 27 | 1514 |
| S8 | 0.1 | 99 | 28 | 1500 |
| S9 | 0.1 | 101 | 29 | 1520 |
| S10 | 0.1 | 113 | 30 | 1454 |
| S11 | 0.1 | 115 | 31 | 1532 |
| S12 | 0.1 | 118 | 31 | 1562 |
| S13 | 0.1 | 120 | 33 | 1574 |
| DS1 | 0.1 | 131 | 32 | 1560 |
| DS2 | 0.1 | 146 | 34 | 1120 |
| DS3 | 0.1 | 156 | 37 | 1421 |
| DS4 | 0.1 | 132 | 32 | 1710 |
| Blank | / | 148 | 35 | 1377 |
| control | | | | |

As can be seen from the results in Table 1, the addition of the viscosity reducers provided by the present invention into the drilling fluids which have not been permeated by crude oil can effectively improve the crude oil intrusion resistance of the drying fluids; compared with the sample which does not add the viscosity reducer, the drying fluid sample with the viscosity reducer added in advance has a lower increase amplitude of the apparent viscosity and a smaller dynamic shear force and can maintain a suitable fluidity, after permeation by crude oil. In addition to maintaining the suitable fluidity, the drilling fluid permeated by crude oil exhibits better electrical stability, and can balance the low apparent viscosity and dynamic shear force and high demulsification voltage in a case of preferably, thus it is more conducive to the recycling of the drilling fluids.
(2) Use to illustrate the inhibitory effect of the viscosity reducers on the increase of viscosity for the drilling fluids permeated by crude oil

At the temperature of 65° C., 20 wt % of crude oil was added into the synthetic drilling fluids, wherein the crude oil was the crude oil derived from E₂S³ horizon of Cenozoic Paleogene system in Jiyang Depression; the drilling fluids permeated by the crude oil were then cooled at room temperature, stirred for 5 min, the viscosity reducers of aforementioned Examples and Comparative Examples were subsequently added, based on 100 parts by weight of the drilling fluid, the dosing amounts of the viscosity reducers were shown in Table 2, after the drilling fluids were cooled to 20° C., the apparent viscosity of the drilling fluids were tested according to the China National Standard GB/T 16783.2-2012 “Petroleum and natural gas industries—Field testing of drilling fluids—Part 2: Oil-based fluids”, the results were shown in Table 2.

TABLE 2

| | Dosing amount of | Apparent viscosity |
|---|---|---|
| Viscosity | viscosity reducer | at 20° C. |
| reducers | (part by weight) | mPa · s |
| S1 | 0.1 | 92 |
| S2 | 0.5 | 94 |
| S3 | 0.2 | 94 |
| S4 | 0.2 | 96 |
| S5 | 0.2 | 96 |
| S6 | 0.2 | 97 |
| S7 | 0.2 | 98 |
| S8 | 0.2 | 97 |
| S9 | 0.2 | 99 |
| S10 | 0.2 | 108 |
| S11 | 0.2 | 110 |
| S12 | 0.2 | 112 |
| S13 | 0.5 | 130 |
| DS1 | 0.2 | 138 |
| DS2 | 0.5 | 157 |
| DS3 | 0.5 | 168 |
| DS4 | 0.5 | 140 |
| Blank control | / | 148 |

The results in Tables 1 and 2 show that the viscosity reducers provided by the invention can be added into the drilling fluids which have not been permeated by crude oil, or added into the drilling fluids after permeation by crude oil during the use process, both can improve the crude-oil pollution resistance of the drilling fluids, and can effectively inhibit an increase of viscosity of the drilling fluids permeated by crude oil.

The above content describes in detail the preferred embodiments of the present disclosure, but the present disclosure is not limited thereto. A variety of simple modifications can be made in regard to the technical solutions of the present disclosure within the scope of the technical concept of the present disclosure, including a combination of individual technical features in any other suitable manner, such simple modifications and combinations thereof shall also be regarded as the content disclosed by the present disclosure, each of them falls into the protection scope of the present disclosure.

1.-14. (canceled)

15. A viscosity reducer, wherein the viscosity reducer comprises a matrix and particles attached to a surface of the matrix and/or wrapped in the matrix, wherein the matrix comprises an oleophilic moiety and a hydrophilic moiety; the particles do not melt at 100° C. or lower; and a number of the particles in the viscosity reducer in an area of 10*10 μm is 1-1,500 according to an analysis using a scanning electron microscope.

16. The viscosity reducer according to claim 15, wherein a ratio of a maximum absorption peak intensity (P1) in an area of 700±50 cm⁻¹ to a maximum absorption peak intensity (P2) in an area of 2920±70 cm⁻¹ in an infrared absorption spectrum of the viscosity reducer is not less than 0.25.

17. The viscosity reducer according to claim 15, wherein the number of the particles in the viscosity reducer in an area of 10*10 μm is 2-1,000, according to an analysis using a scanning electron microscope;
and/or, wherein a mass ratio of the matrix to the particles is 1:0.01-0.5.

18. The viscosity reducer according to claim 15, wherein a particle size is within a range of 300 nm-5 μm;
and/or, the oleophilic degree of said particles at 20° C. is not less than 50%.

19. The viscosity reducer according to claim 15, wherein the particles are at least one selected from the group consisting of organic particles, inorganic oxide particles and organic-inorganic composite particles.

20. The viscosity reducer according to claim 19, wherein the particles are at least one of polymethyl methacrylate particles, polyethyl methacrylate particles, glycidyl methacrylate particles and polyethylene terephthalate particles.

21. The viscosity reducer according to claim 15, wherein the matrix has a hydrophilic-oleophilic balance value within the range of 3-5;
and/or, the oleophilic moiety comprises at least one oleophilic functional group, the hydrophilic entity comprises at least one hydrophilic functional group, and the molar ratio of the oleophilic functional group to the hydrophilic functional group in the matrix is 8-90:1.

22. The viscosity reducer according to claim 21, wherein the oleophilic functional group is contained in an amount of 80-95 wt % based on a total amount of the matrix.

23. The viscosity reducer according to claim 21, wherein the oleophilic functional group is at least one selected from the group consisting of substituted or unsubstituted ester, alkyl, alkenyl, alkynyl, and aryl groups; and/or
the hydrophilic functional group is at least one selected from the group consisting of hydroxyl, carboxyl, anhydride and amino group.

24. The viscosity reducer according to claim 15, wherein the matrix and the particles comprise an identical structural unit.

25. The viscosity reducer according to claim 24, wherein a ratio of a molar amount of the identical structural unit contained in the matrix to a molar amount of the identical structural unit contained in the particles in the viscosity reducer is 1-30:1.

26. The viscosity reducer according to claim 15, wherein the matrix is a polymer, and the matrix has a weight average molecular weight within a range of 5,000-50,000 g/mol.

27. The viscosity reducer according to claim 26, wherein the matrix comprises a structural unit A represented by formula (1) and a structural unit B represented by formula (2): 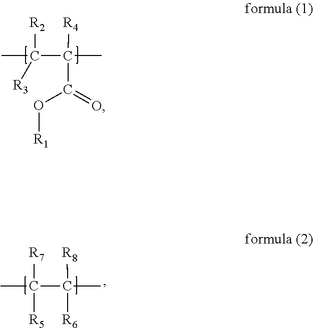
wherein R₁, R₂, R₃ and R₄ are each independently selected from hydrogen atom, C16-C22 alkyl, C16-C22 alkenyl, C16-C22 alkynyl or C16-C22 aryl group, and at least one of R₁, R₂, R₃ and R₄ is not hydrogen atom;
R₅, R₆, R₇ and R₈ comprise at least one hydroxyl, carboxyl or amino, or R₅ and R₆ are connected to form an acid anhydride, or R₇ and R₈ are connected to form an acid anhydride.

28. The viscosity reducer according to claim 27, wherein a molar ratio of the structural unit A to the structural unit B in the polymer is 1-10:1.

29. A preparation method for a viscosity reducer, the preparation method comprises the following steps: mixing a matrix with particles in a molten state, and then drying the mixture; the matrix comprises an oleophilic moiety and a hydrophic moiety; the particles do not melt at 100° C. or lower, and a mass ratio of a dosage of the matrix to the particles is 1:0.01-0.5.

30. The preparation method according to claim 29, wherein a particle size is within a range of 300 nm-5 μm;
and/or, the mass ratio of the dosage of the matrix to the particles is 1:0.02-0.07;
and/or, mixing conditions comprise: a mixing temperature within a range of 100-180° C., and a mixing time within a range of 5-30 min;
and/or, the drying is carried out under vacuum condition, a drying temperature is within a range of 60-80° C., and a drying time is within a range of 10-12 h.

31. A method for using the viscosity reducer according to claim 15 in viscosity reduction of a drilling fluid permeated by crude oil.

32. A method for improving crude-oil pollution resistance of a drilling fluid, wherein the method comprises adding the viscosity reducer according to claim 15 into the drilling fluid.

33. The method according to claim 32, wherein the drilling fluid is an oil-based drilling fluid or a synthetic drilling fluid.

34. The method according to claim 32, wherein a dosage of the viscosity reducer is 0.05-1 part by weight, relative to 100 parts by weight of the drilling fluid.
